(19) United States
(12) Patent Application Publication
(10) Pub. No.: US 2022/0199302 A1
(43) Pub. Date: Jun. 23, 2022

(54) Transformer and Method of Engineering a Transformer to Incorporate a Leakage Inductance

(71) Applicants: Alex Leary, Cleveland, OH (US); Paul Richard Ohodnicki, JR., Allison Park, PA (US); Carnegie Mellon University, Pittsburgh, PA (US); North Carolina State University, Raleigh, NC (US)

(72) Inventors: Richard Byron Beddingfield, Cary, NC (US); Paul Richard Ohodnicki, Jr., Allison Park, PA (US); Kevin Byerly, Pittsburgh, PA (US); Subhashish Bhattacharya, Raleigh, NC (US); Michael Edward McHenry, Jr., Pittsburgh, PA (US); Alex Leary, Cleveland, OH (US)

(21) Appl. No.: 17/604,180

(22) PCT Filed: Apr. 20, 2020
(86) PCT No.: PCT/US2020/028990

§ 371 Date: Oct. 15, 2021

Related U.S. Application Data
(60) Provisional application No. 62/920,215, filed on Apr. 18, 2019.

(51) Int. Cl. H01F 1/14; H01F 41/02; H01F 27/24; H01F 27/02; H01F 27/28

(52) U.S. Cl. CPC H01F 1/14; H01F 41/0206; H01F 27/28; H01F 27/022; H01F 27/24

(57) ABSTRACT

A transformer includes a core formed of at least one MANC alloy. The MANC alloy has a predefined permeability.

### CROSS-REFERENCE TO RELATED APPLICATION

This application claims priority to U.S. Provisional Patent Application No. 62/920,215, filed Apr. 18, 2019, the disclosure of which is hereby incorporated by reference in its entirety.

### GOVERNMENT LICENSE RIGHTS

This invention was made with Government support under DE-EE00031004, DE-AC02-06CH11357, and DE-FE0004000, awarded by the Department of Energy. The Government has certain rights in the invention.

### BACKGROUND

### 1. Field

This disclosure relates generally to transformers. The disclosed concept also relates to a method of engineering a transformer to include a leakage inductance.

### 2. Technical Considerations

Cores can be integrated within a transformer to provide for a controlled level of leakage inductance during operation. Air cores have a minimal permeability and require large volumes and high turns for a given equivalent inductance. Gapped cores display complex flux distributions in the vicinity of gaps, including fringing flux which can overlap with adjacent windings and result in greater electromagnetic interference and proximity losses. These conventional cores do not provide ideal characteristics for leakage inductance in transformer designs.

### SUMMARY

In one aspect, a transformer is provided. The transformer includes a core formed of at least one metal amorphous nanocomposite (“MANC”) alloy. The MANC alloy has a predefined permeability.

In another aspect, a method of engineering a transformer to incorporate a leakage inductance is provided. The method includes forming a core of at least one MANC alloy, the at least one MANC alloy having a predefined permeability, and incorporating the core into the transformer.

Further embodiments or aspects are set forth in the following numbered clauses:

Clause 1: A transformer comprising: a core formed of at least one MANC alloy, the at least one MANC alloy comprising a predefined permeability.

Clause 2: The transformer of clause 1, wherein the core comprises a first soft magnetic core and a second soft magnetic core each being ungapped, wherein the first core has a first predefined permeability and the second core has a second predefined permeability different than the first predefined permeability.

Clause 3: The transformer of clauses 1 or 2, wherein the first core comprises an outer core of the transformer, wherein the second core comprises an inner core of the transformer, and wherein the second predefined permeability is less than the first predefined permeability.

Clause 4: The transformer of any of clauses 1-3, wherein the first core comprises an outer core of the transformer, wherein the second core comprises an inner core of the transformer, and wherein the second predefined permeability is greater than the first predefined permeability.

Clause 5: The transformer of any of clauses 1-4, wherein the transformer comprises a primary winding encompassing the first core and the second core, and a secondary winding encompassing the first core.

Clause 6: The transformer of any of clauses 1-5, wherein, responsive to the secondary winding being open and current being applied to the primary winding, magnetizing flux in the transformer is primarily contained in the first core, with the second core being at least partially excited.

Clause 7: The transformer of any of clauses 1-6, wherein, responsive to the primary winding being open and current being applied to the secondary winding, the first core is excited and the second core experiences substantially zero excitation.

Clause 8: The transformer of any of clauses 1-7, wherein, responsive to the secondary winding being short circuited and current being applied to the primary winding, magnetizing flux within the first core is substantially eliminated, and leakage flux within the second core and associated with the primary winding are retained.

Clause 9: The transformer of any of clauses 1-8, wherein the core further comprises a third soft magnetic core, wherein the first core is disposed internally within the second core, and wherein the second core is disposed internally within the third core.

Clause 10: The transformer of any of clauses 1-9, wherein the third core is a magnetizing core, wherein the second core is an outer leakage core, and wherein the first core is an inner leakage core.

Clause 11: The transformer of any of clauses 1-10, further comprising a primary winding, a secondary winding, and a tertiary winding, wherein the primary winding is disposed internal with respect to the first core, wherein the secondary winding is disposed between the first core and the second core, and wherein the tertiary winding is disposed between the second core and the third core.

Clause 12: The transformer of any of clauses 1-11, wherein, responsive to power flowing between the primary winding and the secondary winding, an effective leakage inductance is dominated by the first core rather than the second core or the third core.

Clause 13: The transformer of any of clauses 1-12, wherein, responsive to power flowing between the secondary winding and the tertiary winding, the second core provides a primary leakage inductance, while the first core and the third core contribute nominally to leakage inductance.

Clause 14: The transformer of any of clauses 1-13, wherein, responsive to power flowing between the primary winding and the tertiary winding, leakage inductance exists due to both the first core and the second core.

Clause 15: The transformer of any of clauses 1-14, wherein the core further comprises a third soft magnetic core, wherein the third core is disposed between the first core and the second core, wherein the first core is disposed on a first side of the third core and the second core is disposed on a second, opposite side of the third core.

Clause 16: The transformer of any of clauses 1-15, wherein the first core comprises a first leakage core, wherein the second core comprises a second leakage core, and wherein the third core comprises a magnetizing core.

Clause 17: The transformer of any of clauses 1-16, wherein the first core is formed of the at least one MANC alloy, and wherein the second core is formed of a non-MANC alloy.

Clause 18. The transformer of any of clauses 1-17, wherein the first core is formed of a MANC alloy and the second core is formed of another MANC alloy.

Clause 19: A method of engineering a transformer to incorporate a leakage inductance, the method comprising: forming a core of at least one MANC alloy, the at least one MANC alloy comprising a predefined permeability; and incorporating the core into the transformer.

Clause 20: The method of clause 19, further comprising forming the core with a first soft magnetic core having a first predefined permeability and a second soft magnetic core having a second predefined permeability different than the first predefined permeability.

Clause 21: The method of clauses 19 or 20, wherein each of the first core and the second core are ungapped.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details are explained in greater detail below with reference to the exemplary embodiments that are illustrated in the accompanying schematic figures, in which:

FIG. 1 is a schematic diagram of a transformer according to a non-limiting embodiment;

FIG. 2 is a graph of measured impedance magnitude as a function of frequency for the transformer primary winding;

FIG. 3 is a graph of a measured impedance phase angle as a function of frequency for the transformer primary winding;

FIG. 4 is a graph of a measured loss of the transformer as a function of peak saturation flux density (B) at a fixed excitation frequency of 10 kHz;

FIG. 5 is a schematic diagram of a transformer according to another non-limiting embodiment;

FIG. 6 is a magnetic equivalent circuit of the transformer of FIG. 5;

FIG. 7 is a schematic diagram of a transformer according to another non-limiting embodiment;

FIG. 8 is a magnetic equivalent circuit of the transformer of FIG. 7;

FIG. 9 shows the inductance sensitivity of various axial designs;

FIG. 10 is a concentric winding open circuit admittance bode plot;

FIG. 11 shows the effective relative permeability of power flor paths in the transformer of FIG. 7 with strain annealed cores;

FIG. 12 shows the effective permeability of open circuit winding in the transformer of FIG. 7 with strain annealed cores;

FIG. 13 shows the efficiency map of the transformer of FIG. 7 with strain annealed leakage cores; and

FIG. 14 shows the normalized specific losses of the transformer of FIG. 7.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

All numbers used in the specification and claims are to be understood as being modified in all instances by the term “about.” The terms “approximately,” “about,” and “substantially” mean a range of plus or minus ten percent of the stated value.

As used herein, the term “metal amorphous nanocomposite material” (MANC) refers to soft magnetic materials (SMMs) featuring low power loss at high frequency and maintaining relatively high flux density. MANCs have metastable nanocomposite structures, which may remain stable to several 100° C. without deleterious secondary crystallization or deterioration of magnetic properties. As an example, a MANC may include an FeNi-based composition. A MANC may include a Cobalt (Co)-based composition. Suitable materials are described in U.S. Patent Application Publication No. 2019/0368013 (application Ser. No. 16/434,869), titled “Fe—Ni Nanocomposite Alloys,” as well as U.S. Pat. No. 10,168,392 (application Ser. No. 14/278,836), titled “Tunable anisotropy of co-based nanocomposites for magnetic field sensing and inductor applications,” the entirety of which are hereby incorporated by reference. MANC alloys are also described in an article in The JOM (The Journal of The Minerals, Metals & Materials Society (TMS)), entitled “Metal Amorphous Nanocomposite (MANC) Alloy Cores with Spatially Tuned Permeability for Advanced Power Magnetics Applications,” published on Apr. 25, 2018, the entirety of which is hereby incorporated by reference.

As used herein, the term “ungapped” or “gapless” refers to soft magnetic cores wherein the core material is continuous along the direction defined by the core's magnetic path length. This may be as in a tapewound core or stacked core from laminations. A gapped core could be a single discrete gap, multiple discrete gaps, or many discrete gaps as in a powder or composite core.

As used herein, the term “predefined permeability” shall mean a permeability value which is imparted to the core through a combination of material selection and processing. One non-limiting embodiment is the tension annealing of a Co-based alloy with a selected tension that produces a desired permeability value. In some non-limiting embodiments, a “predefined permeability” may instead include a range of varying permeabilities spatially throughout a core.

Non-limiting embodiments are directed to new transformer architectures which leverage ungapped cores of engineered permeability for the purpose of integrated leakage inductance and minimized eddy current losses associated with fringing flux generated normal to the surface of tape wound cores. Through the application of “tuned permeability” leakage flux cores, combinations of higher power densities and efficiencies can be achieved for the following reasons: 1) Integrated leakage inductance into the transformer designs can enable higher power densities as well as simpler packaging schemes and approaches; 2) Leakage cores can guide the “leakage flux” that is not coupled between the transformer windings to avoid stray flux normal to the surface of tape wound cores; and 3) Controlled flux densities within leakage cores allow for optimizing trade-offs between losses and power density by reducing the volume needed for achieving a desired leakage inductance.

In non-limiting embodiments, a transformer achieves these advantages by being formed from a core comprising one or more MANC alloys, which are ungapped and have a permeability engineered to a specific value through thermal processing in a magnetic field, an applied mechanical stress, or any combination thereof. The application of such cores has unique advantages as compared to alternatives such as air cores or gapped cores for at least the following reasons: 1) Air cores have a minimal permeability and require large volumes and high turns for a given equivalent inductance; and 2) Gapped cores display complex flux distributions in the vicinity of gaps, including fringing flux which can overlap with adjacent windings and result in greater electromagnetic interference and proximity losses.

In contrast with the above characteristics, permeability engineered and ungapped magnetic cores comprised of metal amorphous and nanocrystalline nanocomposite cores can yield combinations of (1) excellent linearity with applied magnetizing field to core saturation, (2) tuned permeability to a target value from as low as ˜5 to as high as ˜50,000, and (3) anisotropic permeabilities which tend to result in greater flux confinement than isotropic permeabilities thereby reducing electromagnetic interference for low effective core permeabilities. Below are more details for several representative designs that exploit the concept disclosed and illustrate relative advantages and unique design approaches which can be realized as a result.

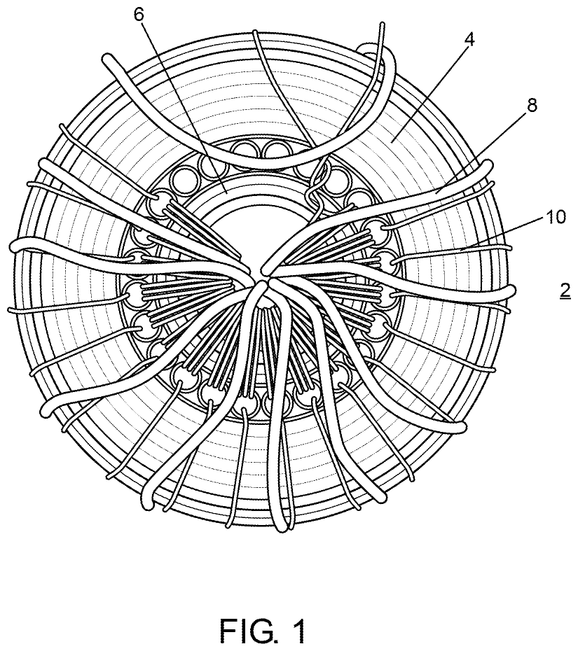

FIG. 1 shows an example transformer (e.g., without limitation, toroidal transformer 2). In one example embodiment, the transformer 2 includes a core formed of at least one MANC alloy, the MANC alloy comprising a predefined permeability. The core has a number of concentric soft magnetic cores 4,6, and the transformer 2 further includes a primary winding 8, and a secondary winding 10. The first and second cores 4,6 may each be ungapped. In one example embodiment, the first core 4 is formed of a MANC alloy and the second core 6 is formed of a non-MANC alloy. In another example embodiment, the first core 4 is formed of a MANC alloy and the second core 6 is formed of a MANC alloy with a different “predefined permeability”. Furthermore, the first core 4 may include an outer core of the transformer 2, and in one example embodiment, is an outer magnetizing core. The first core 4 provides for the magnetizing path of the transformer 2 and may include a relatively high permeability Fe-based MANC. The second core 6 may include an inner core of the transformer 2, and in one example embodiment, is an inner leakage core. The second core 6 may be only magnetically coupled to the primary winding 8, and may have a relatively low tuned value of permeability achieved through strain annealing of a Co-based MANC composition in order to provide for an asymmetric inductance when a short circuit test is performed. Additionally, in the transformer 2 of FIG. 1, the second core 6 is also held together mechanically and is able to be excited by a third set of dense turns of magnet wire, which are not electrically coupled to the primary and secondary windings 8,10. However other means of mechanically affixing the core to the transformer without electrical coupling can be envisioned. Furthermore, the first core 4 may have a first predefined permeability, and the second core 6 may have a second predefined permeability different (e.g., less or greater) than the first predefined permeability. As shown in FIG. 1, the primary winding 8 encompasses the first core 4 and the second core 6, while the secondary winding 10 encompasses the first core 4.

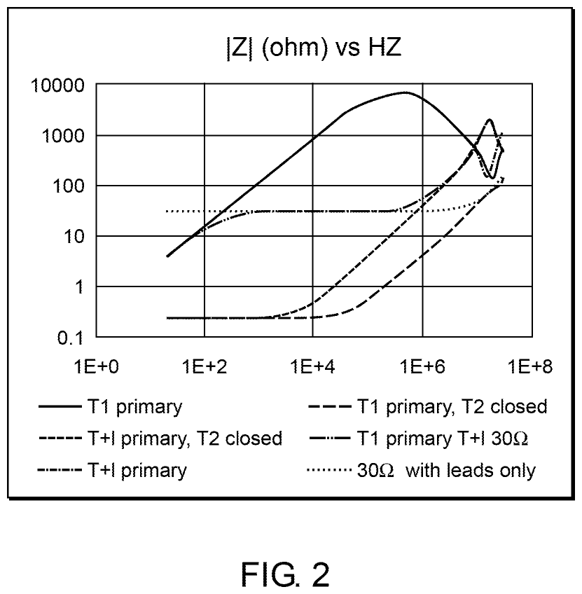

Low power tests with an impedance analyzer show the expected frequency dependent magnitude and phase of the impedance response of a device of the present invention comprised of two magnetic cores and two coil windings. The material used for the first, outer core 4 was FeSiNbMoBCu nanocomposite, and the material used for the second, inner core 6 was Co-rich stress annealed with a relative permeability of 50. To show the impedance responses, FIGS. 2-4 correspond to a design with three 12 turn windings, two around the outer core only (T1 and T2 windings similar to the secondary winding 10 of FIG. 1) and one winding around both cores (T+I winding similar to the primary winding 8 of FIG. 1).

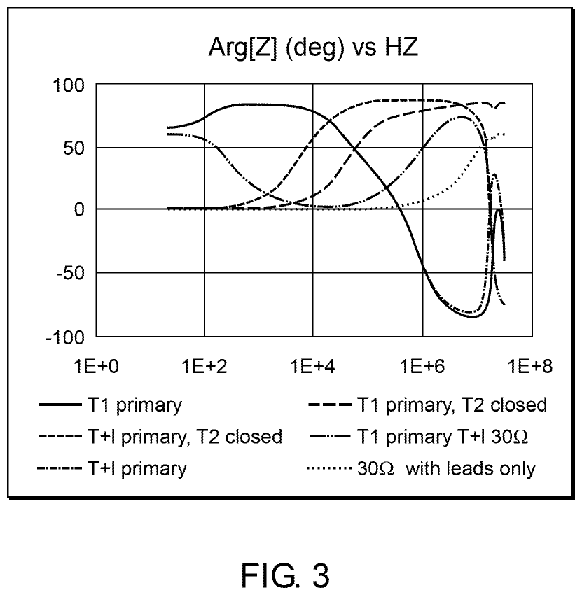

During testing of the transformer, as shown in FIGS. 2-3, current was applied to one winding at a time, designated the primary winding, with the other windings in different configurations. Unless otherwise noted, these other windings were in the open, or unconnected, configuration so that no significant current passed through the other two windings. The impedance of the T1 and T+I in the primary condition with all other windings open are very similar. However, the inductance of the T+I winding with T2 closed (shorted) is higher compared to the inductance of the T1 winding with T2 closed. This is due to the additional inductance of the second inner core that does not have magnetic flux significantly linked through T2. To simulate a loading condition, a 30 ohm resistor was connected across the T+I winding. Good regulation through the device is possible until frequencies where the additional series inductance from the inner leakage core approaches the load impedance as shown. The impedance of the resistor with leads is added for comparison.

FIG. 3 shows the phase angle of the impedances under the previously described conditions. Responsive to the secondary winding T2 being open and current being applied to the primary winding T+I, magnetizing flux in the transformer is primarily contained in the first core 4, with the second core 6 being at least partially excited. Because the first core 4 has a much higher relative permeability, most of the magnetizing flux is contained in the first core 4, but the second core 6 is also excited to a lesser extent. However, responsive to the primary winding T+I being open and current being applied to the secondary winding T1, the first core 4 is excited and the second core 6 experiences substantially zero excitation. Specifically, only weak, residual stray flux from the secondary winding T2 approaches the second, inner leakage core 6 in this example. In another simulation, responsive to the secondary winding T2 being short circuited and current being applied to the primary winding T+I, magnetizing flux within the first core 4 is substantially eliminated, and leakage flux within the second core 6 and associated with the primary winding 8 are retained. In this configuration, leakage flux is dominated by the flux within the second, inner leakage core 6, thereby providing a tunable leakage inductance that mitigates against flux normal to the tape wound core surfaces.

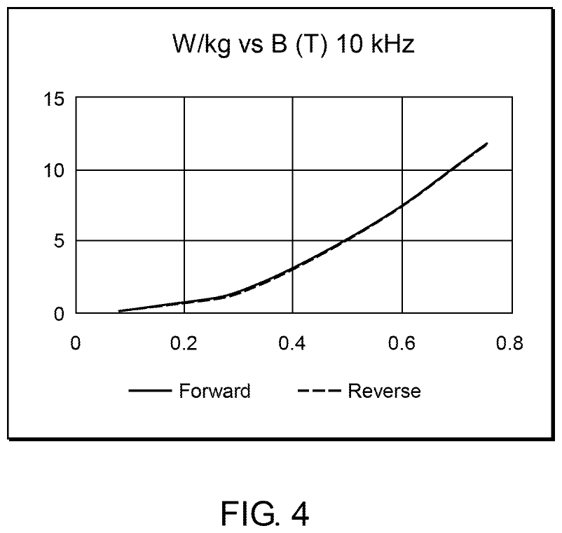

FIG. 4 shows core losses, measured in the first core 4 of the given example by applying a magnetizing current through the T1 winding and measuring flux with the T+I winding (forward configuration) and by applying a magnetizing current through the T+I winding and measuring the flux in the T1 winding (reverse configuration). The physical size of the first core 4 was used in both cases to measure flux density and the core loss in the first core 4 under these conditions. The core losses in both cases are shown to be very similar, with little impact in the first core 4 due to the addition of the second core 6.

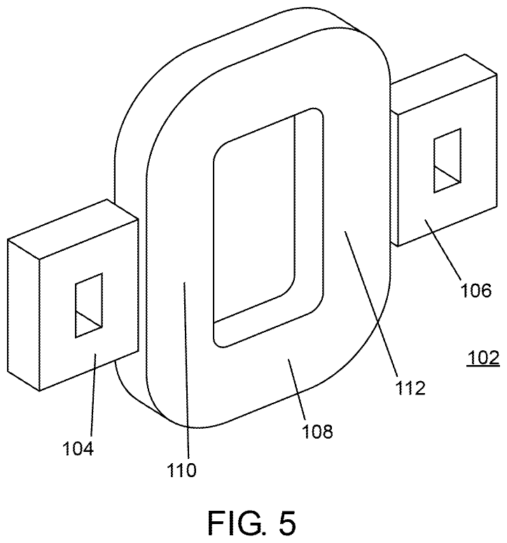

FIG. 5 shows a schematic view of a transformer 102, in accordance with another embodiment of the disclosed concept. In this embodiment, strain annealed leakage cores are integrated in order to increase the leakage inductance and minimize the amount of stray flux normal to the magnetizing core surface for a given target leakage inductance. The transformer 102, like the transformer 2, discussed above, includes a core formed of at least one MANC alloy, the MANC alloy including a predefined permeability. As shown, the core includes a first soft magnetic core 104, a second soft magnetic core 106, and a third soft magnetic core 108 located between the first core 104 and the second core 106. The first core 104 is located on a first side 110 of the third core 108 and the second core 106 is located on a second, opposite side 112 of the third core 108. In one example embodiment, the first core 104 is a first leakage core, the second core 106 is a second leakage core, and the third core 108 is a magnetizing core.

In one example, the assumed excitation condition is a primary excitation with a shorted secondary winding. In this example, one of the strain annealed first and second cores 104,106 (e.g., the first core 104) are analyzed at an example relative permeability of 50, with the third, magnetizing core 108 analyzed at an example relative permeability of approximately 20,000. The inventors have discovered that the predominant component of leakage flux is contained in the third core 108, and the tunability of the strain annealed first core 104 has a range of about 3-100 for the most commonly explored Co-based strain annealed composition, thus yielding a wide range of design choices. As a result, an explicit design of the effective series inductance and magnetizing inductance can be performed with a significant reduction in the amount of leakage flux which must penetrate the broad surface of the tape wound cores.

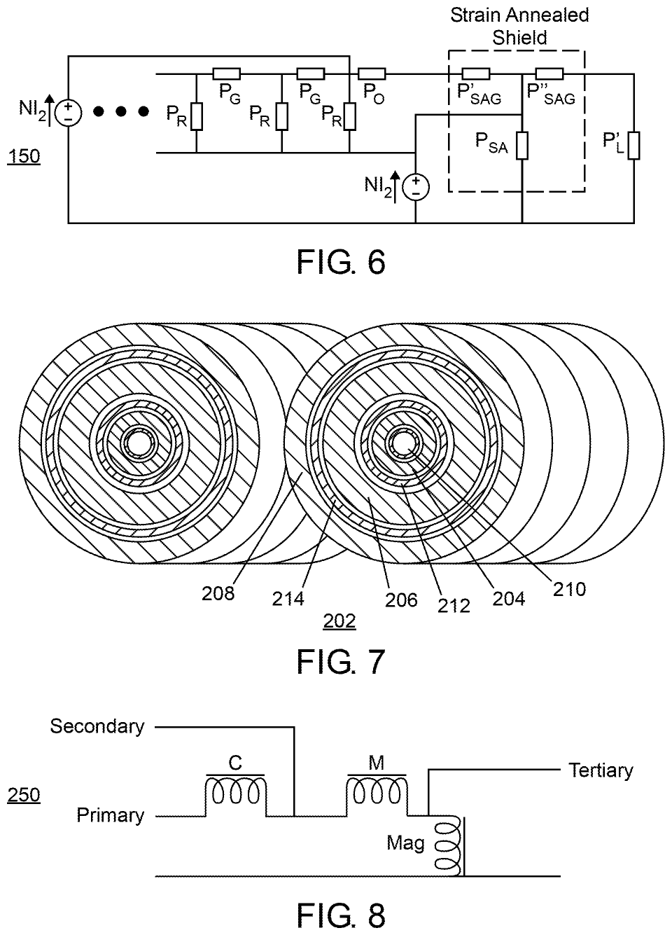

FIG. 6 shows a magnetic equivalent circuit 150 of the transformer 102, shown in FIG. 5. The circuit 150 is comprised of a componentized permeance model of the flow of magnetic flux parallel (P_{R}) and normal (P_{G}) to the magnetizing axis of the third, magnetizing core 108 as well as parallel (P_{SA}) and normal (P_{SAG}) to the strain annealed leakage core, as well as along the face of the magnetizing and leakage cores.

Moreover, if an uncut strain annealed shield material is used, \hat{P}′_{L}, the permeance associated with the constituent geometries around the face of the shield core and \hat{P}″_{L} and the permeance associated with the geometries around the leakage core would both be minimal relative to the permeance associated with the magnetizing core 108 and the strain annealed core. As a result, the independent design of magnetizing inductance and leakage inductance can be achieved pursuant to Equations 1 and 2 below, where the third, magnetizing core 108 has a relative permeability of μᵣ and the strain annealed core has a relative permeability of μ_{SA} and μᵣ>>μ_{SA}.

L_{mag}=N²\hat{P}_{core}∝μᵣ; Equation 1:

Lₗₑₐₖ=N²\hat{P}_{SA}∝μ_{SA} Equation 2:

By taking advantage of the relative tunability of leakage inductance, asymmetric series inductances can be achieved by using different relative permeabilities and designs for the shield cores. This advantage is particularly significant for multi-winding designs for enhanced converter controllability by providing designers the opportunity to have different impedences for different nodes. An even more advanced design strategy would integrate a subset of coil windings around the leakage core and the remainder around the magnetizing core alone. This gives the designer an ability to design for a wider range of inductances in the case where attainable permeabilities are limited due to materials or manufacturing constraints, as presented below in Equations 3 and 4.

L_{mag}∝(Nₚₐᵣₜᵢₐₗ+N_{remainder})²μᵣ; Equation 3:

Lₗₑₐₖ∝Nₚₐᵣₜᵢₐₗ²μ_{SA} Equation 4:

FIG. 7 shows a schematic view of another transformer 202, in accordance with another embodiment of the disclosed concept. The transformer 202, like the transformers 2,102 discussed above, includes a core formed of at least one MANC alloy, the MANC alloy including a predefined permeability. As shown, the core includes a first soft magnetic core 204, a second soft magnetic core 206, and a third soft magnetic core 208. The cores 204,206,208 are concentric with each other, such that first core 204 is located internally within the second core 206, and the second core 206 is located internally within the third core 208. Although the transformer 202 is being described herein in association with the three concentric cores 204,206,208, it is contemplated that any suitable alternative number of cores may be employed, without departing from the scope of the disclosed concept. This is a significant advantage for magnetic ribbon wound cores as there are minimal dimensional limitations. Rather than needing a larger press and extreme pressures as is the case for ferrites or powder cores, ribbons need only a larger winding mandrel. In one example, the first core 204 is an inner leakage core, the second core 206 is an outer leakage core, and the third core 208 is a magnetizing core.

Continuing to refer to FIG. 7, the transformer 202 further includes a primary winding 210, a secondary winding 212, and a tertiary winding 214. The primary winding 210 is located internally within the first core 204, the secondary winding 212 is located between the first core 204 and the second core 206, and the tertiary winding 214 is located between the second core 206 and the third core 208.

An important aspect of the transformer 202 is that the core is arranged around the coil, and the coil is wound as an elongated round torus. That is, the wire bundle in the core region is preferably circular as a concentric foil and conductor cylinder, or an assembly of wires in such a configuration. Multiple coils can be added as additional concentric rings to provide the required turns ratios for the transformer design requirements. Each coil excites the magnetic cores that is exterior to the winding, but does not excite cores that are contained within the winding resulting in significant asymmetry in the design. A primary advantage of the instant axial design is that the magnetic flux remains within the thin lamination of the tape-wound cores due to the geometry, thereby minimizing stray field losses due to generated eddy currents which result from more traditional designs.

More specifically, all of the coils see the magnetizing inductance. However, responsive to power flowing between the primary winding 210 and the secondary winding 212, an effective leakage inductance is dominated by the first core 204 rather than the second core 206 or the third core 208. Additionally, responsive to power flowing between the secondary winding 212 and the tertiary winding 214, the second core 206 provides a primary leakage inductance, while the first core 204 and the third core 208 contribute nominally to leakage inductance. Furthermore, responsive to power flowing between the primary winding 210 and the tertiary winding 214, leakage inductance exists due to both the first core 204 and the second core 206. In accordance with the disclosed embodiment, the different inductances are again tunable by the relative permeability and the number of turns. However, the example geometry also allows inductance tuning by the length of the winding surrounded by the first, second, and third cores 204,206,208.

Another advantage of the transformer 202 is that the parasitic capacitance is minimized and somewhat controllable which is an additional benefit provided by the presence of the leakage cores between windings. The tape-wound cores are highly electronically conductive and can therefore act as a Faraday shield separating the windings, such that the winding to winding capacitance is due only to the winding overlap that is outside the cores. This contribution may be minimized through careful winding geometries and techniques.

Axial designs, e.g., the transformer 202, align a toroidal core axis with the centerline axis of flux. A two winding design is called a coaxial design, and a three winding design may supply two different output voltages. An advantage of the axial design is the explicit and easily predicable control of the leakage inductance. The design can include multiple windings and still operate effectively, demonstrating that a semi aligned flux axis and core axis is still effective. Furthermore, the leakage inductance can be boosted by adding magnetic cores between layers of excitation coils. The instant design follows the traditional approaches of designing axial magnetics but employs strain annealed cores to achieve the desired leakage inductance. This approach provides another design tool to control the leakage core flux density as well as gain important inductance tunability independent of the volume. For a high-power density design, this is a critical improvement in the design process.

In one example embodiment, the leakage cores (e.g., the first and second cores 204,206) are ungapped toroids. For these toroids to remain ungapped, special care must be applied to design of the core dimensions. One additional design variable is relative permeability of the leakage core, μ_{[m/c]}, where the subscript represents the specific core. This design flexibility is achieved by utilizing advanced manufacturing techniques. Specifically, a cobalt rich MANC ribbon has an excellent response to strain and tests have found a range of about 150 to near 8 relative permeability for this core material. This enables further independence in inductance design, e.g., Equations 5 and 6 below.

$$\begin{matrix}{L}_{m} = {N}^{2} \frac{d {μ}_{rm} {μ}_{0}}{2 π} ln ( \frac{{R}_{oo}}{{R}_{oi}} ) ; & Equation 5 \\ {L}_{l} = {N}^{2} \frac{d {μ}_{[ m / c ]} {μ}_{0}}{2 π} ln ( \frac{{R}_{[ m / c ] o}}{{R}_{[ m / c ] i}} ) & Equation 6\end{matrix}$$

The leakage inductances will then have a flux density related to the current flow through the leakage path in the electrical model.

With only two leakage cores and their spatial orientation, the electrical equivalent circuit of the triaxial transformer is asymmetric. See, for example, equivalent circuit 250 of the transformer 202, shown in FIG. 8. The circuit 250 can be derived by observing a core and determining which cores are excited in an open circuit test. Starting with the center, primary winding 210, it is clear that all three cores 204,206,208 are excited when this coil is energized. When the center, secondary winding 212 is energized, only the middle and magnetizing cores 206,208 are excited because the magnetic flux will not be inside the conductor radius. Lastly, the third, tertiary winding 214 only energized the magnetizing core 208 and none of the leakage cores 204,206.

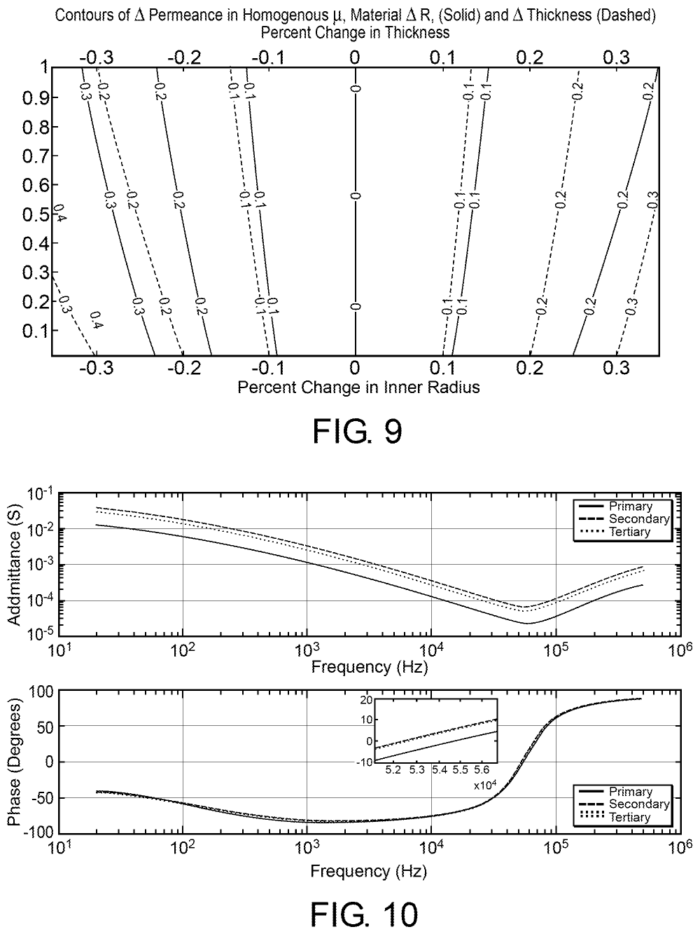

FIG. 9 shows a plot of the inductance sensitivity of various axial designs. The plot in FIG. 9 shows how incremental changes in either thickness or inner radius will impact the inductance value. When available, decreasing the inner radius increases inductance most effectively while the thickness reduces the inductance most effectively.

FIG. 10 is a concentric winding open circuit admittance bode plot. To generate this plot, the self-capacitances were determined by subjecting the winding to an admittance sweep with the other windings opened. It is worth noting that capacitance between the primary coil, the center winding 210, and the tertiary coil, the outer-most winding 214, is roughly half of the other series parasitic capacitances. This is due to the large physical space between these windings. This feature can be leveraged as a critical path for the highest required dv/dt.

With the lower capacitance, this will result in less common mode noise than other configurations. Another key point is that this approach tends to overestimate the winding self-capacitance when a coil bundle is not fully packed in the perimeter. That is, when the outer perimeter of the coil is not filled by windings that are tangentially touching, the winding self-capacitance is lower. This is shown in the case of the primary and tertiary windings 210,214. The secondary winding 212, which is tightly packed, is well represented by the concentric cylinder model and the length of the core region. The prediction of loosely packed winding capacitances can be improved by estimating the proportion of surface that is not covered by windings. The primary winding 210 has wire guide bobbins that orient the winding and leave nearly 50% of the surface uncovered. Similarly, the tertiary winding 214 has significant bunching and only covers about 40% of the area. These reductions can bring the estimated capacitance within ±5%.

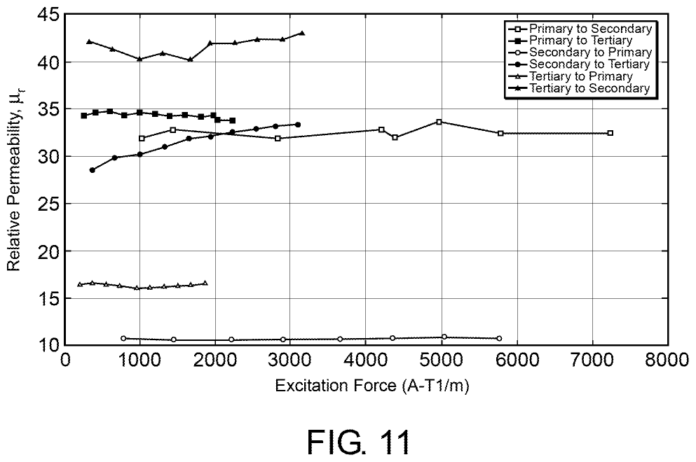

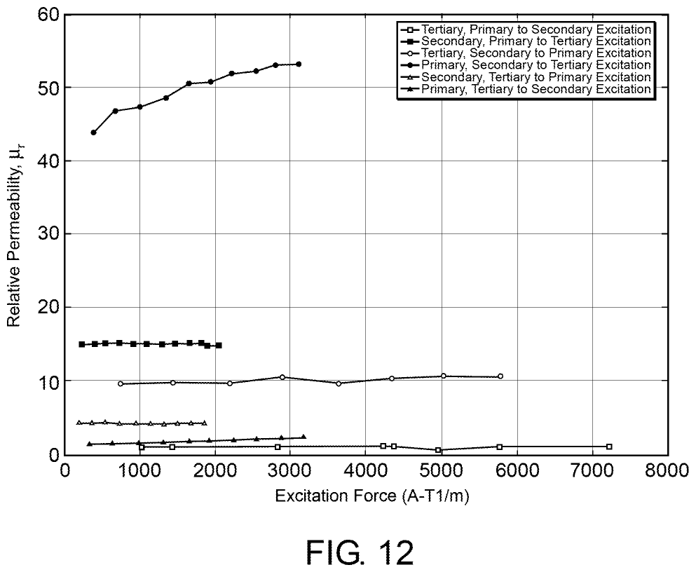

The transformer 202 was also subjected to an active bridge emulation test. This characterization method leads to interesting insights into the behavior of the transformer 202. First, the performance of the strain annealed leakage flux cores is shown in the plot of FIG. 11. This shows that cores excited from the primary winding 210 generally exhibit expected behavior. However, excitation from the outer winding towards the center show a reduced effective permeability. This asymmetry can be leveraged in active bridge controls for intelligent power flow control that utilized the different effective series impedances of the various paths. Furthermore, when power is flowing between two windings, the third winding is generally unexcited, as shown in the plot of FIG. 12. As the effective permeability of these paths is very low or even near one, neither the leakage core nor the magnetizing core is excited. Utilizing this concept could enable intelligent converter control that completely turns a converter off for specific power flow instances. This may provide significant power savings as that converter would no longer contribute switching losses to the system total losses.

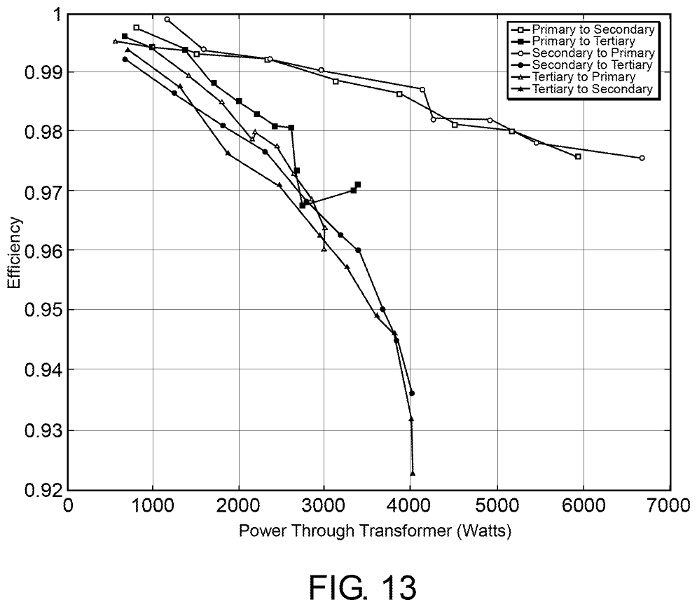

FIG. 13 shows an efficiency map, developed by emulating an active bridge, as just described, for the transformer 202. This map demonstrates the application of the dual voltage source converter emulating an active bridge power flow, and also proves that the transformer 202 can effectively operate as a three port transformer.

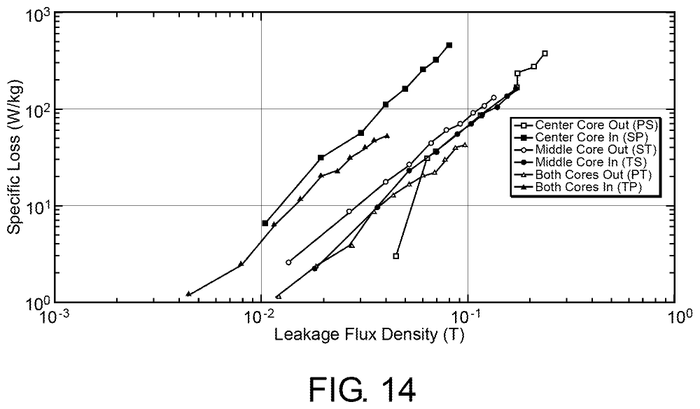

With the distinct difference in power flow path efficiencies of FIG. 13, it is important to analyze the specific mass dependent losses of the leakage cores (e.g., first and second cores 204,206). FIG. 14 shows that the leakage loss cores generally perform the same. The primary difference is when power flow is inwards and through the secondary winding 212. It is clear that this geometry introduces significant additional losses.

It will also be appreciated that a method of engineering one of transformers 2,102,202 to incorporate a leakage inductance includes the steps of forming a core of at least one MANC alloy, the at least one MANC alloy having a predefined permeability; and incorporating the core into the transformer 2,102,202. The method may further include forming the core with a first soft magnetic core having a first predefined permeability and a second soft magnetic core having a second predefined permeability different than the first predefined permeability. Cores of predefined permeability may have a uniform permeability within the core or may alternatively have a spatial variation in permeability.

Although non-limiting embodiments have been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A transformer comprising:
a core formed of at least one MANC alloy, the at least one MANC alloy comprising a predefined permeability.

2. The transformer of claim 1, wherein the core comprises a first soft magnetic core and a second soft magnetic core each being ungapped, wherein the first core has a first predefined permeability and the second core has a second predefined permeability different than the first predefined permeability.

3. The transformer of claim 2, wherein the first core comprises an outer core of the transformer, wherein the second core comprises an inner core of the transformer, and wherein the second predefined permeability is less than the first predefined permeability.

4. The transformer of claim 2, wherein the first core comprises an outer core of the transformer, wherein the second core comprises an inner core of the transformer, and wherein the second predefined permeability is greater than the first predefined permeability.

5. The transformer of claim 2, wherein the transformer comprises a primary winding encompassing the first core and the second core, and a secondary winding encompassing the first core.

6. The transformer of claim 5, wherein, responsive to the secondary winding being open and current being applied to the primary winding, magnetizing flux in the transformer is primarily contained in the first core, with the second core being at least partially excited.

7. The transformer of claim 5, wherein, responsive to the primary winding being open and current being applied to the secondary winding, the first core is excited and the second core experiences substantially zero excitation.

8. The transformer of claim 5, wherein, responsive to the secondary winding being short circuited and current being applied to the primary winding, magnetizing flux within the first core is substantially eliminated, and leakage flux within the second core and associated with the primary winding are retained.

9. The transformer of claim 2, wherein the core further comprises a third soft magnetic core, wherein the first core is disposed internally within the second core, and wherein the second core is disposed internally within the third core.

10. The transformer of claim 9, wherein the third core is a magnetizing core, wherein the second core is an outer leakage core, and wherein the first core is an inner leakage core.

11. The transformer of claim 9, further comprising a primary winding, a secondary winding, and a tertiary winding, wherein the primary winding is disposed internal with respect to the first core, wherein the secondary winding is disposed between the first core and the second core, and wherein the tertiary winding is disposed between the second core and the third core.

12. The transformer of claim 9, wherein, responsive to power flowing between the primary winding and the secondary winding, an effective leakage inductance is dominated by the first core rather than the second core or the third core.

13. The transformer of claim 9, wherein, responsive to power flowing between the secondary winding and the tertiary winding, the second core provides a primary leakage inductance, while the first core and the third core contribute nominally to leakage inductance.

14. The transformer of claim 9, wherein, responsive to power flowing between the primary winding and the tertiary winding, leakage inductance exists due to both the first core and the second core.

15. The transformer of claim 2, wherein the core further comprises a third soft magnetic core, wherein the third core is disposed between the first core and the second core, wherein the first core is disposed on a first side of the third core and the second core is disposed on a second, opposite side of the third core.

16. The transformer of claim 15, wherein the first core comprises a first leakage core, wherein the second core comprises a second leakage core, and wherein the third core comprises a magnetizing core.

17. The transformer of claim 2, wherein the first core is formed of the at least one MANC alloy, and wherein the second core is formed of a non-MANC alloy.

18. The transformer of claim 2, wherein the first core is formed of a MANC alloy and the second core is formed of another MANC alloy.

19. A method of engineering a transformer to incorporate a leakage inductance, the method comprising:
forming a core of at least one MANC alloy, the at least one MANC alloy comprising a predefined permeability; and
incorporating the core into the transformer.

20. The method of claim 19, further comprising forming the core with a first soft magnetic core having a first predefined permeability and a second soft magnetic core having a second predefined permeability different than the first predefined permeability.

21. The method of claim 19, wherein each of the first core and the second core are ungapped.
